(19) United States
(12) Patent Application Publication
(10) Pub. No.: US 2006/0191325 A1
(43) Pub. Date: Aug. 31, 2006

(54) Heat conductor with detection element and testing method thereof

(75) Inventors: Ming-Cyuan Shih, Jhubei City (TW); Sin-Wei He, Jhudong Township (TW); Jhong-Yan Chang, Chu Pei City (TW)

Correspondence Address: John S. Egbert;Harrison & Egbert, 7th Floor, 412 Main Street, Houston, TX, 77002, US

(73) Assignee: FORCECON TECHNOLOGY Co., Ltd., Chu Pei City (TW)

(21) Appl. No.: 11/068,454

(22) Filed: Feb. 28, 2005

(51) Int. Cl. G01M 3/04

(52) U.S. Cl. 73/49.2

(57) ABSTRACT

The heat conductor with a micro detection element and a testing method thereof. The method includes injecting the micro detection element into the heat conductor after completion of vacuum pumping for the heat conductor. The micro detection element generally refers to inert gases of lighter atomic weight, such as helium and argon, etc. Next, the heat conductor is sealed. Secondly, a detector is used to detect if there is any leakage of micro detection element from exterior of heat conductor. The invention makes possible speeding up the test process and quickly identifying the vacuum state of heat conductor for a higher availability.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to the testing method and construction of a heat conductor, and more particularly to an innovative design that a heat conductor includes a micro detection element for rapid detection of the vacuum state.

### BACKGROUND OF THE INVENTION

To ensure a better heat conduction effect, a heat conductor is generally fitted with an opening at one side for vacuum pumping. After that, it is required to keep the vacuum constant by sealing this preset opening. However, defective products shall be screened via a testing method since the vacuum state of finished products cannot be identified apparently after sealing of opening. According to existing testing methods, the finished heat conductor shall be continuously warmed up after vacuum pumping & sealing, i.e. seasoning, thereby promoting the reliability and stabilizing the quality of heat conductor. Once upon cooling down, one side of the heat conductor is heated up (e.g. soaked in thermal fluid), while the heat conduction speed is tested at the other side. In the presence of abnormally slow speed or excessive temperature difference for both sides, they are proved non-conforming products below a vacuum state. Based on practical experience of testing methods for the conventional heat conductor, it can be learnt that, the process of testing one side's heat conduction via heating of the other side must wait for identification of vacuum state by heat transfer from one side to the other side, thus leading to a time-consuming operation. And, the testing time will be obviously prolonged with the increasing length of heat conductors to be tested, offering a lower availability for this industry.

Thus, to overcome the aforementioned problems of the prior art heat conductor, it would be an advancement in the art to provide an improved one that can speed up the testing process.

To this end, the inventor has provided the present invention of practicability after deliberate design and evaluation based on years of experience in the production, development and design of related products.

### BRIEF SUMMARY OF THE INVENTION

Based on this innovative design that heat conductor of the present invention is detected by an injecting micro detection element, it is possible to improve a time-consuming and slow testing process of testing one side's heat conduction via heating of the other side. In the present invention, only a detector is required to detect if there is any leakage of micro detection element from exterior of heat conductor, thereby facilitating the detection of any leakage, and promoting considerably the testing efficiency in a cost-effective manner to meet the industrial requirement for a higher availability.

### BRIEF DESCRIPTION OF THE SEVERAL VIEWS OF THE DRAWINGS

FIG. 1 shows a flowchart of the testing method of the present invention.

FIG. 2 shows a plane view of the first step of the testing method.

FIG. 3 shows a plane view of the second step of the testing method.

FIG. 4 shows a plane view of the third step of the testing method.

FIG. 5 shows a plane view of the fourth step of the testing method.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

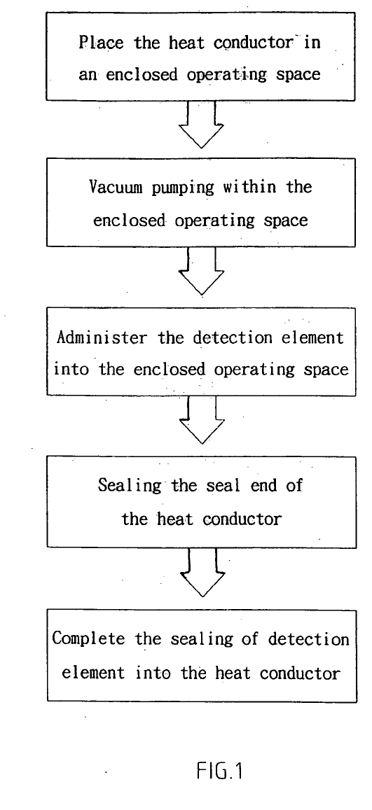

As shown in FIGS. 1-4, the testing method of a heat conductor with detection elements embodied in the present invention comprises:

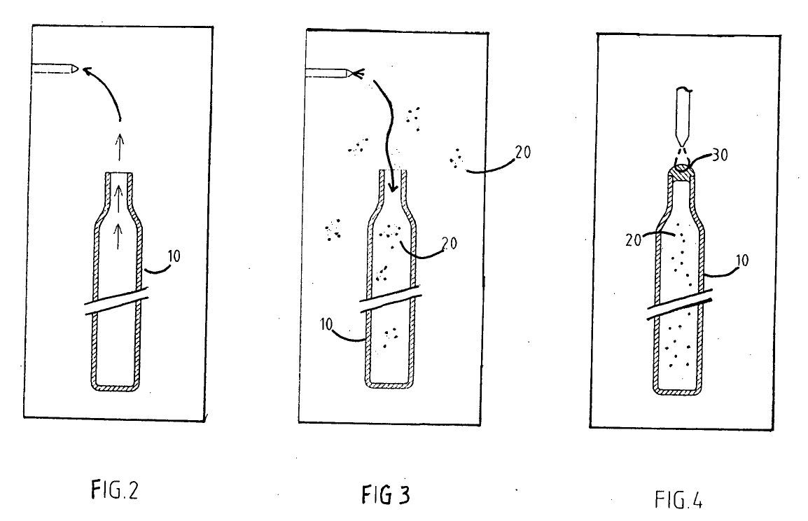

a. As shown in FIG. 2, vacuum pumping is performed within the heat conductor 10;

b. As shown in FIG. 3, micro detection element 20 is injected into heat conductor 10 after completion of vacuum pumping of heat conductor. The micro detection element generally refers to inert gases of lighter atomic weight, such as helium and argon, etc, which will be discharged if there is still any gap after sealing of heat conductor;

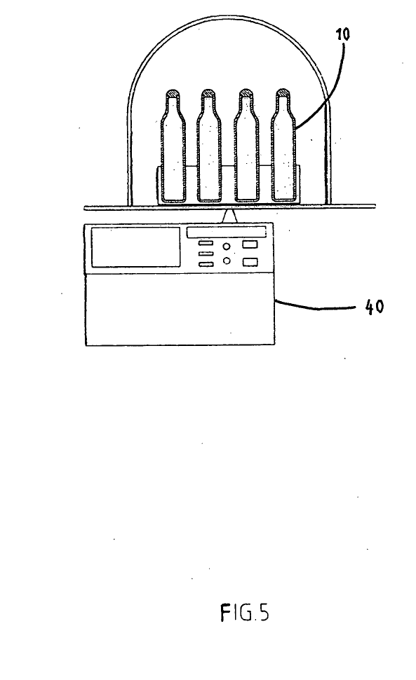

c. As shown in FIG. 4, the heat conductor 10 is sealed by soldering flux 30 or pressing methods;

d. As shown in FIG. 5, a special detector 40 for aforementioned micro detection element 20 is used to detect if there is any leakage of micro detection element 20 from exterior of heat conductor 10 (Figure hereto shows that some heat conductors 10 are placed in an enclosed container for detection purpose). Therefore, it is possible to identify if there is any leakage within heat conductor 10.

Prior to detection of any leakage of micro detection element 20, a seasoning procedure shall be incorporated to promote the reliability and stabilizing the quality of heat conductor 10.

Of which, the micro detection element 20 generally refers to inert gases of lighter atomic weight, such as helium and argon.

Of which, the use level of micro detection element 20 exceeds 1×10⁻⁸ torr of internal partial pressure of heat conductor 10.

As shown in FIG. 4 for the construction of heat conductor 10 of present invention, a hollow space is placed within the heat conductor 10, and two close ends at both sides. And, aforementioned micro detection element 20 is provided within the hollow space of heat conductor 10.

Additionally, the heat conductor of present invention can be designed with piping, turreted or plate profiles.

1. A testing method of a heat conductor with detection elements said method comprising the steps of:
injecting, after completion of vacuum pumping, a micro detection element into a heat conductor, which is then enclosed; and
using a special detector for said micro detection element to detect if there is any leakage of micro detection element from exterior of heat conductor identifying if said heat conductor is in a vacuum state.

2. The testing method of a heat conductor with detection elements as defined in claim 1, further comprising:
seasoning said heat conductor prior to detection of any leakage of micro detection element.

3. The testing method of a heat conductor with detection elements as defined in claim 1, wherein said micro detection element is comprised of helium and argon.

4. The testing method of a heat conductor with detection elements as defined in claim 1, wherein using said special detector sets a use level of said micro detection element exceeding 1×10⁻⁸ torr of internal partial pressure of heat conductor.

5. A heat conductor with detection element comprising:
a hollow space; and
an enclosed housing, a micro detection element being injected into the hollow space.

6. A heat conductor with detection element as defined in claim 5, wherein said micro detection element is comprised of helium and argon.

7. A heat conductor with detection element as defined in claim 5, wherein a use level of said micro detection element exceeds 1×10⁻⁸ torr of internal partial pressure of heat conductor.
